(19) United States
(12) Patent Application Publication
(10) Pub. No.: US 2007/0094427 A1
(43) Pub. Date: Apr. 26, 2007

(54) SYSTEM AND METHOD FOR VERIFYING THE COUPLED LOCATIONS OF COMPUTER DEVICES

(75) Inventors: Hoi Chan, Shenzhen (CN); Ru-Da Xu, Shenzhen (CN); Yue Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,464

(22) Filed: Aug. 10, 2006

(30) Foreign Application Priority Data
Oct. 26, 2005 (CN) 200510100777.6

(51) Int. Cl. G06F 13/00

(52) U.S. Cl. 710/104

(57) ABSTRACT

A method for verifying the coupled locations of computer devices is provided. The method includes the steps of: (a) mapping a logical address of each device interface on a standard motherboard to a physical address of the device interface on the standard motherboard; (b) storing all mapping relationships in a database; (c) obtaining a list of devices linked to the standard motherboard of a computer to be verified from a BOM; (d) determining a logical address of each device according to product assembly standards; (e) obtaining a standard physical address of each device according to its logical address and a mapping relationship in the database; (f) writing the standard physical address of each device into a device specification file; and (g) checking the validity of installation locations of devices of the computer to be verified based on the device specification file.

### FIELD OF THE INVENTION

The present invention generally relates to systems and methods for verifying coupled locations of devices of electronic devices, and more particularly to a system and method for verifying the coupled locations of computer devices.

### DESCRIPTION OF RELATED ART

A standard motherboard is the largest and most fundamental device of a computer; most other devices of the computer are directly or indirectly integrated to the standard motherboard. As a common intermediary between all devices of the computer to communicate and work together, the standard motherboard has a series of slots, sockets, and connectors, which all kinds of devices are coupled with, such as peripheral component interconnect (PCI) devices, universal serial bus (USB) devices, integrated device electronic (IDE) devices, and so on. Each device has a corresponding position (interface) on the standard motherboard based on computer assembly standards, which corresponds to a logical address and a physical address that define as follows: the logical address of the interface is an address given by people in order to identify and differentiate the interface from other interfaces during computer assembling; the physical address of the interface is an address given by the standard motherboard in order to manage the interface. Before shipment, these devices have to undergo a series of procedural tests to check their operability. A hardware test for verifying the accuracy of coupled locations of these devices is also included.

A conventional method used by manufacturers to verify the coupled locations of computer devices is shown in FIG.1: in step S10, a test engineer assembles a standard computer based on a bill of materials (BOM) and computer assembly standards for a line of computers having one kind of device specification. In step S12, an application program captures device specification information of the standard computer, such as standard physical addresses of devices on a standard motherboard of the standard computer, and stores the device specification information into a device specification file. In step S14, the test engineer copies the device specification file into each computer having the same device specification as the standard computer for the hardware test. In step S16, A testing program verifies the coupled locations of devices of the computer with the hardware test based on the device specification file.

One drawback of the above method, however, is that if there are a large amount of computers having different device specifications but using a same set of standard motherboards, engineers would still need to assemble various corresponding standard computers so as to acquire corresponding various device specification files for computers for the hardware test. It's all known that computers with the same kind of standard motherboards may have omnifarious device specifications, so the above method results in repetitious workload on redundant data.

Furthermore, manual work is also applied in installation of each standard computer, thus labor cost and error probabilities are both increased.

What is needed, therefore, is a method for verifying the coupled locations of computer devices with higher efficiency and lower inaccuracy.

### SUMMARY OF THE INVENTION

A system for verifying the coupled locations of computer devices in accordance with a preferred embodiment is provided. The system includes: a mapping module for mapping a logical address of each device interface on a standard motherboard to a physical address of the device interface on the standard motherboard; a location obtaining module for obtaining a logical address of each device linked to the standard motherboard of a computer based on computer assembly standards and a bill of material, and for obtaining a standard physical address of the device based on the logical address and a corresponding mapping relationship of an device interface, to which the device is linked; and a writing module for writing the standard physical addresses of all the devices into a device specification file.

A computer-based method for verifying the coupled locations of computer devices in accordance with a preferred embodiment is provided. The method includes the steps of: (a) mapping a logical address of each device interface on a standard motherboard to a physical address of the device interface on the standard motherboard; (b) storing all mapping relationships in a database; (c) obtaining a list of devices linked to the standard motherboard of a computer for verifying from a bill of material; (d) determining a logical address of each device according to computer assembly standards, the device being linked to a corresponding device interface on the standard motherboard; (e) obtaining a standard physical address of the device according to the logical address and a mapping relationship in the database; (f) writing the standard physical addresses of all the devices into a device specification file and storing the device specification file in the database; and (g) checking the validity of assembly locations of devices of the computer based on the device specification file.

In summary, the method can realize offering device specification files for computers with the same kind of standard motherboard without assembling standard computers, so as to verify the accuracy of assembly locations of devices of each computer. No matter how many device specifications a passel of computers have, as long as their standard motherboards are of the same kind, standard physical addresses of devices can be foreseen based on computer assembly standards and mapping relationships of device interfaces on their standard motherboards.

Other objects, advantages and novel features of the present invention will be drawn from the following detailed description of the preferred embodiment and preferred method of the present invention with the attached drawings.

### BRIEF DESCRIPTION OF THE DRAWINGS

FIG. 1 is a flowchart of a conventional method for verifying the validity of assembly locations of computer devices;

FIG. 2 is a block diagram illustrating a preferred system for verifying the validity of assembly locations of computer devices;

FIG. 3 is a data flow diagram illustrating a preferred method for verifying the validity of assembly locations of computer devices;

FIG. 4 is a flowchart of the preferred method for verifying the validity of assembly locations of computer devices;

FIG. 5 is a detailed description of one step in FIG. 4, namely mapping a logical address of each device interface on a standard motherboard to a physical address of the device interface on the standard motherboard; and

FIG. 6 is a detailed description of another step in FIG. 4, namely verifying the validity of assembly locations of devices of a computer.

### DETAILED DESCRIPTION OF THE PREFERRED EMBODIMENT

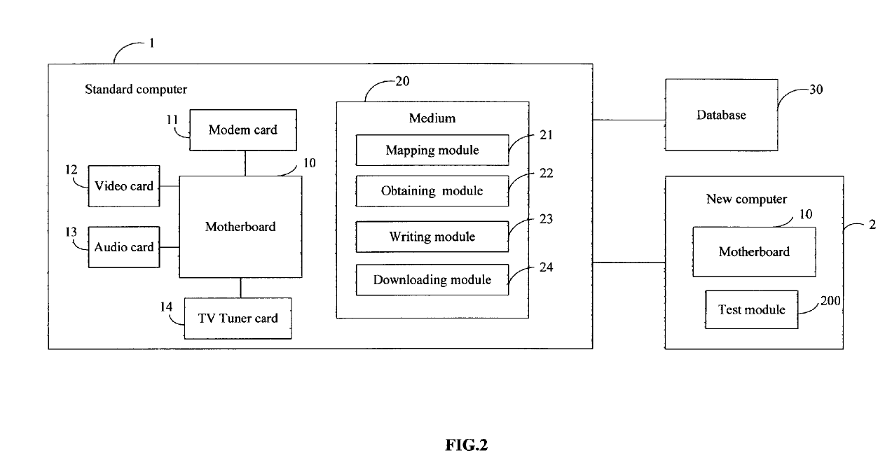

FIG. 2 is a block diagram illustrating a preferred system for verifying the coupled locations of computer devices (hereinafter, “the system”). The system includes a standard computer 1, a database 30, and a plurality of new computers 2 to be verified (only one shown). The standard computer 1 includes a standard motherboard 10, a medium 20, and a plurality of standard devices coupled to the standard motherboard 10, such as a modem card 11, a video card 12, an audio card 13, a TV Tuner card 14, and so on. The standard computer 1 is mainly used for obtaining all logical-physical address mapping relationships (hereinafter, “mapping relationships”) of the device interfaces on the standard motherboard 10.

The database 30 stores information needed or generated by utilizing the system, such as BOMs for assembling various computers, computer assembly standards, standard device specification files for verification, mapping relationships of device interfaces corresponding the standard motherboard 10, and so on. Each new computer 2 employs the same standard motherboard 10 model type employed in the standard computer 1, however, the device specifications of the new computer 2 may be different from the standard computer 1, i.e., devices coupled to the new computer 2 is a subset of the plurality of standard devices that have been coupled the standard computer 1. Furthermore, the new computer 2 has a test module 200.

The medium 20 includes: a mapping module 21, an obtaining module 22, a writing module 23, and a downloading module 24. The mapping module 21 is used for mapping a standard logical address of each device interface on the standard motherboard 10 of the standard computer 1 to a standard physical address of the device interface on the standard motherboard 10 of the standard computer 1 correspondingly, and for storing all the mapping relationships of the device interfaces on the standard motherboard 10 in the database 30. The obtaining module 22 is used for obtaining the standard logical address of each standard device linked to the standard motherboard 10 of the standard computer 1, and a logical address of each selected device linked to the standard motherboard 10 of the new computer 2 both based on computer assembly standards, and further used for deducing a standard physical address of each selected device coupled to the standard motherboard 10 of the new computer 2 based on the selected device's logical address and a mapping relationship corresponding the device interface of the standard motherboard 10. The writing module 23 is used for writing the standard physical address of each selected device of the new computer 2 into a standard device specification file and storing the standard device specification file in the database 30.

The downloading module 24 is used for downloading the standard device specification file from the database 30 onto each new computer 2 for verification. The test module 200 is used for verifying the coupled locations of selected devices of the new computer 2 based on the standard device specification file, for example, comparing a real physical address of each selected device with the standard physical address of the selected device recorded in the standard specification file to determine whether the coupled location of the selected device in the new computer 2 is correct. The medium 20 can be a portable hard disk or any other kind of storage device that can be accessed by any computer systems.

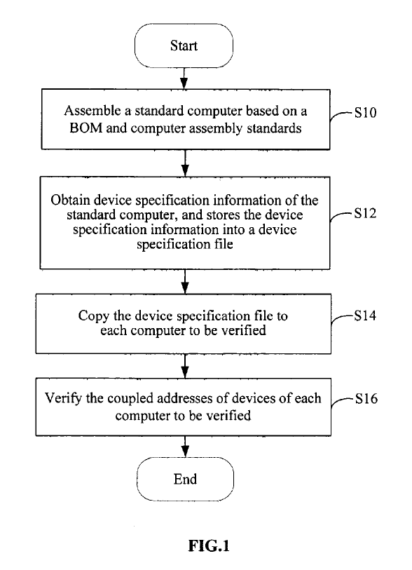

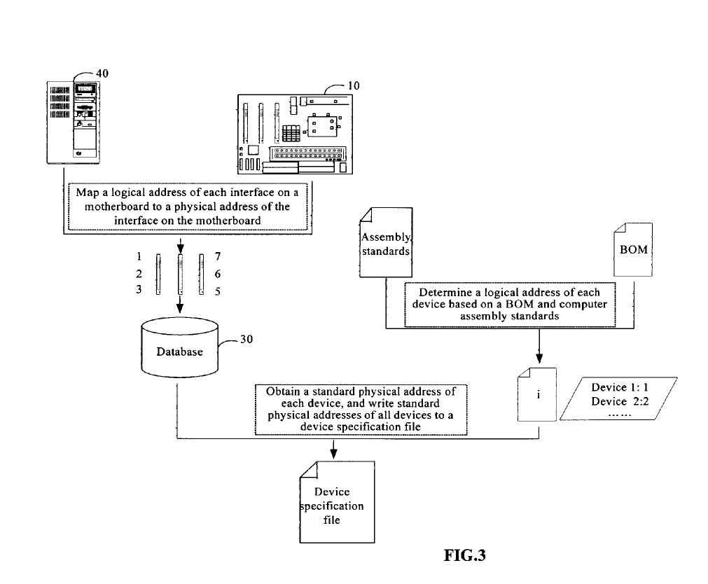

FIG. 3 is a data flow diagram for verifying the coupled locations of computer devices. Supposing that there are various computers employing the same model type as the standard motherboard 10 having different device specifications. Firstly, a variety of standard devices are coupled to corresponding device interfaces on the standard motherboard 10 to form the standard computer 1 as shown in FIG. 1 based on computer assembly standards. The standard devices may be a modem card 11, a video card 12, an audio card 13, a TV Tuner card 14, and any other appropriate computer devices. The mapping module 21 then maps the standard logical address of each device interface on the standard motherboard 10 of the standard computer 1 to the standard physical address of the device interface on the standard motherboard 10 of the standard computer 1 correspondingly, and stores the mapping relationships in the database 30.

Secondly, the obtaining module 22 obtains the list of selected devices coupled to the standard motherboard 10 of the new computer 2 to be verified from a corresponding BOM, and obtains the logical address of each selected device of the new computer 2 based on the computer assembly standards. Then the obtaining module 22 obtains the standard physical address of each selected device of the new computer 2 according to its logical address and the mapping relationship of the device interface that the selected device is coupled to.

Afterwards, the writing module 23 writes standard physical addresses of all the selected devices of the new computer 2 into the standard device specification file and stores the standard device specification file in the database 30 for future hardware testing.

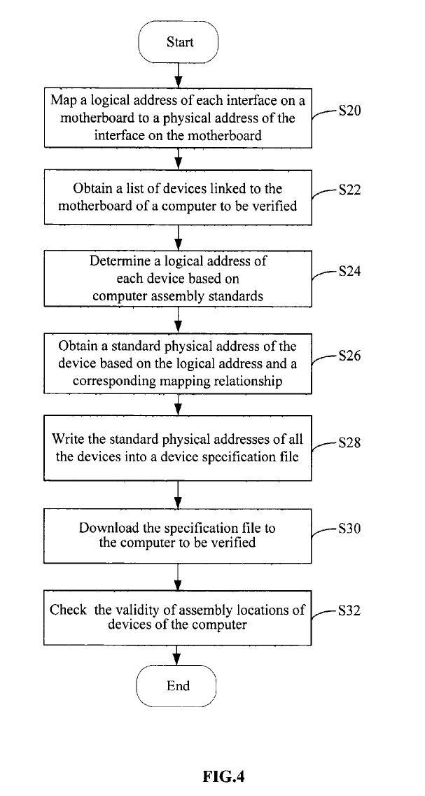

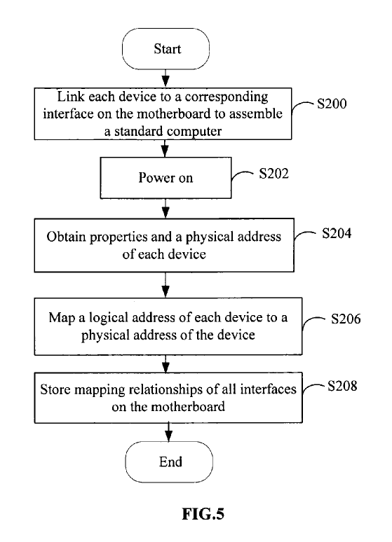

FIG. 4 is a flowchart of a preferred method for verifying the validity of assembly locations of computer devices. In step S20, the mapping module 21 maps the standard logical address of each device interface on the standard motherboard 10 of the standard computer 1 to the standard physical address of the device interface on the standard motherboard 10 of the standard computer 1, and stores the mapping relationships of all device interfaces on the standard motherboard 10 in the database 30 (detailed description is given in FIG. 5). In step S22, the obtaining module 22 obtains the list of selected devices coupled to the standard motherboard 10 of the new computer 2 to be verified from the corresponding BOM in the database 30.

In step S24, the obtaining module 22 obtains the logical address of each selected device coupled to the standard motherboard 10 of the new computer 2 based on computer assembly standards. In step S26, the obtaining module 22 deduces the standard physical address of each selected device coupled to the standard motherboard 10 of the new computer 2 according to its logical address and the mapping relationship of the device interface coupled to the selected device.

In step S28, the writing module 23 stores the standard physical addresses of all selected devices and other selected device specification information into the standard device specification file, such as “PCI Amount=‘2’,Unit0.BusNO=‘0×01’, Unit0.DevNO=‘0×02’,Unit0.FunNo=‘0×00’”, etc., and stores the standard device specification file in the database 30.

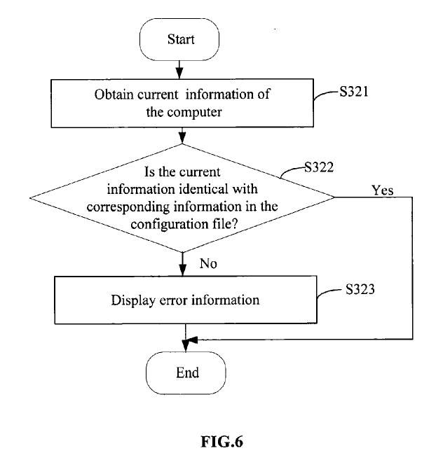

In step S30, the downloading module 24 downloads the standard device specification file from the database 30 to any new computer 2 employing the same model type as the standard motherboard 10 and the selected devices. In step S32, the test module 200 checks the coupled locations of selected devices of the new computer 2 based on the standard device specification file (detailed description is given in FIG. 6).

FIG. 5 is a detailed description of step S20 in FIG. 4. In step S200, an operator links each standard device to the corresponding device interface on the standard motherboard 10, based on the standard logical address of the device interface and computer assembly standards, to assemble the standard computer 1. For example, a first modem card of A brand (such as the modem card 11) should be corresponding to a logical slot 1 on the standard motherboard 10, a second modem card of B brand should be corresponding to a logical slot 2, and a TV tuner card of C brand (such as the TV tuner card 14) should be corresponding to a logical slot 3.

In step S202, the standard computer 1 is booted up. In step S204, the obtaining module 22 obtains properties and standard physical addresses of each standard device. For example, the first modem card may be corresponding to a physical slot 7, the second modem card may be corresponding to a physical slot 6, and the TV tuner card may be corresponding to a physical slot 5. In step S206, the mapping module 21 maps the standard logical address of each device interface on the standard motherboard 10 to the standard physical address of each device interface on the standard motherboard 10. As described above, the logical slot 1 maps the physical slot 7, the logical slot 2 maps the physical slot 6, and the logical slot 3 maps the physical slot 5. In step S208, the writing module 23 stores the mapping relationships of the standard device interfaces in the database 30.

FIG. 6 is a detailed description of step 32 in FIG. 4. In step S321, the test module 200 obtains current information of the new computer 2 including real physical address of all the selected devices. In step S322, the test module 200 determines whether the current information is identical with corresponding information in the standard device specification file, for example, whether the real physical address of each selected device is the same as the standard physical address of the selected device recorded in the standard device specification file. If the current information is not identical with the corresponding information in the device specification file, in step S323, the test module 200 displays error information.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for verifying the coupled locations of computer devices, the system comprising:
a mapping module for mapping a logical address of each device interface on a standard motherboard to a physical address of the device interface on the standard motherboard;
a location obtaining module for obtaining a logical address of each device linked to the standard motherboard of a computer to be verified based on computer assembly standards and a bill of material, and for obtaining a physical address of the device based on the logical address and a corresponding mapping relationship of a device interface to which the device is linked; and
a writing module for writing the physical addresses of all the devices into a device specification file.

2. The system according to claim 1, further comprising a database for storing the device specification file.

3. The system according to claim 1, further comprising a downloading module for downloading the device specification file from the database to the computer to be verified.

4. A computer-based method for verifying the coupled locations of computer devices, the method comprising the steps of:
mapping a logical address of each device interface on a standard motherboard to a physical address of the device interface on the standard motherboard;
storing all the mapping relationships in a database;
obtaining a list of devices linked to the standard motherboard of a computer to be verified from a bill of material;
determining a logical address of each device according to computer assembly standards, the device being linked to a corresponding device interface on the standard motherboard;
obtaining a standard physical address of the device according to the logical address and a mapping relationship in the database;
writing the standard physical addresses of all the devices into a device specification file and storing the device specification file in the database; and
checking the validity of assembly locations of devices of the computer to be verified based on the device specification file.

5. The method according to claim 4, further comprising the step of downloading the device specification file from the database to the computer to be verified.

6. The method according to claim 4, wherein the mapping step comprises the steps of:
linking each device to a corresponding device interface on the standard motherboard based on a logical address of the device interface;
obtaining properties and a physical address of the device; and
mapping the logical address of the device interface on the standard motherboard to the physical address of the device interface on the standard motherboard.

7. The method according to claim 4, wherein the checking step comprise the steps of: obtaining current information of the computer to be verified;
determining whether the current information is identical with corresponding information in the device specification file; and
displaying error information, if the current information is not identical with the information in the device specification file.

8. The method according to claim 4, wherein the logical address of each device interface on the standard motherboard is an address given by people in order to identify and differentiate the interface from other interfaces during computer assembling.

9. The method according to claim 4, wherein the physical address of each interface is an address given by the standard motherboard in order to manage the interface.
